(19) United States
(12) Patent Application Publication
(10) Pub. No.: US 2006/0196076 A1
(43) Pub. Date: Sep. 7, 2006

(54) Dryer seal

(76) Inventors: James L. Justice III, Moore, SC (US); Joseph C. Moon, Greer, SC (US)

Correspondence Address: JAMES M. ROBERTSON, 233 SOUTH PINE STREET, SPARTANBURG, SC, 29302, US

(21) Appl. No.: 11/362,688

(22) Filed: Feb. 27, 2006

Related U.S. Application Data
(60) Provisional application No. 60/657,675, filed on Mar. 1, 2005.

(51) Int. Cl. F26B 11/02; F26B 25/00

(52) U.S. Cl. 34/601; 34/242

(57) ABSTRACT

A dryer seal. The seal includes a first layer of fibrous material adapted to be disposed in contacting relation with a rotating dryer drum and at least one underlying layer held in melt bonded relation to a support structure.

### CROSS-REFERENCE TO RELATED APPLICATIONS

This application claims priority from U.S. Provisional Application 60/657,675 having a filing date of Mar. 1, 2005, the contents of which are hereby incorporated by reference in their entirety.

### TECHNICAL FIELD

This invention relates to a dryer seal and more particularly to a dryer seal providing a bearing surface to support the drum. The seal is adapted to be suitable for meltable bonding to an underlying surface such as a portion of a forward air duct thereby providing a bearing seal that both supports the drum and blocks undesired air flow.

### BACKGROUND OF THE INVENTION

Automatic clothes dryers typically include a housing (also known as a bulkhead) and a rotating drum supported within the housing. It is known to use seal elements in the form of rings of felt which may be disposed between the housing and the drum so as to bear against the drum as it rotates. The use of a sealing element is desirable to prevent air leakage between the drum and the clothes dryer cabinet which could detrimentally affect the air flow system of the dryer.

It is known to utilize seals in the form of ring structures of fibrous material adhesively bonded to a supporting structural member so as to block undesired air flow. While such structures may be effective in blocking the air flow, their assembly utilizing adhesives may be problematic due to the need for precision placement in order to meet tight tolerances. Moreover, over time and exposure to heat, the adhesives may begin to degrade thereby causing a loss of efficiency.

### SUMMARY OF THE INVENTION

This invention provides advantages and/or alternatives over the prior art by providing a dryer seal of multi-layer construction having a low friction bearing layer for disposition in contacting relation with a portion of the dryer drum and an underlying melt bonding layer adapted to be meltably attached to an underlying support surface within the dryer. The combination of the two layers provides an effective seal providing bearing support to the drum while eliminating the need for adhesives to hold the seal in place.

### BRIEF DESCRIPTION OF THE DRAWINGS

The following drawings which are incorporated in and which constitute a part of this specification illustrate an exemplary embodiment of the present invention and, together with the general description above and the detailed description set forth below, serve to explain the principles of the invention wherein:

FIG. 1 is a perspective view of an exemplary clothes dryer with the rotating drum and seal illustrated in phantom; and

FIG. 2 is an exploded cut-away view of a dryer with the seal arranged for mounting with the seal at the interior of the drum; and

FIG. 3 is a view illustrating the ring configuration of the seal.

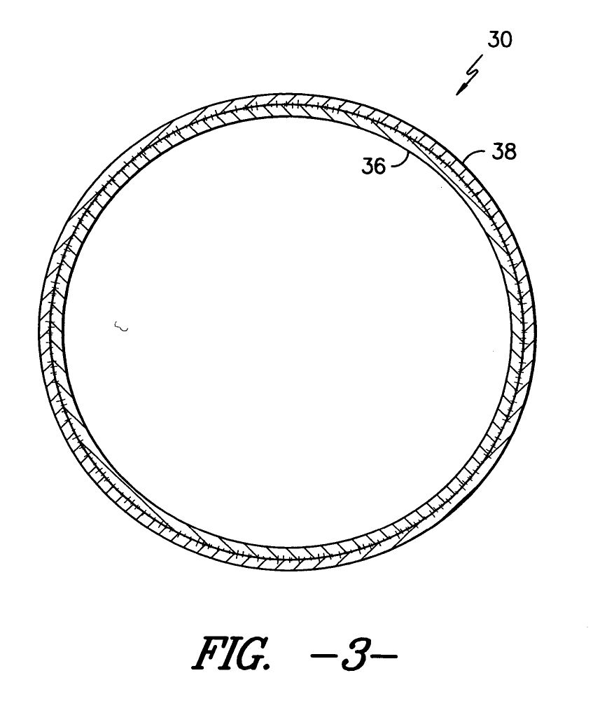

While the invention has been generally described above and will hereinafter be described in connection with certain potentially preferred embodiments and procedures, it is to be understood and appreciated that in no event is the invention to be limited to such illustrated and described embodiments and procedures. On the contrary, it is intended that the present invention shall extend to all alternatives and modifications as may embrace the broad principles of this invention within the true spirit and scope thereof.

### DESCRIPTION

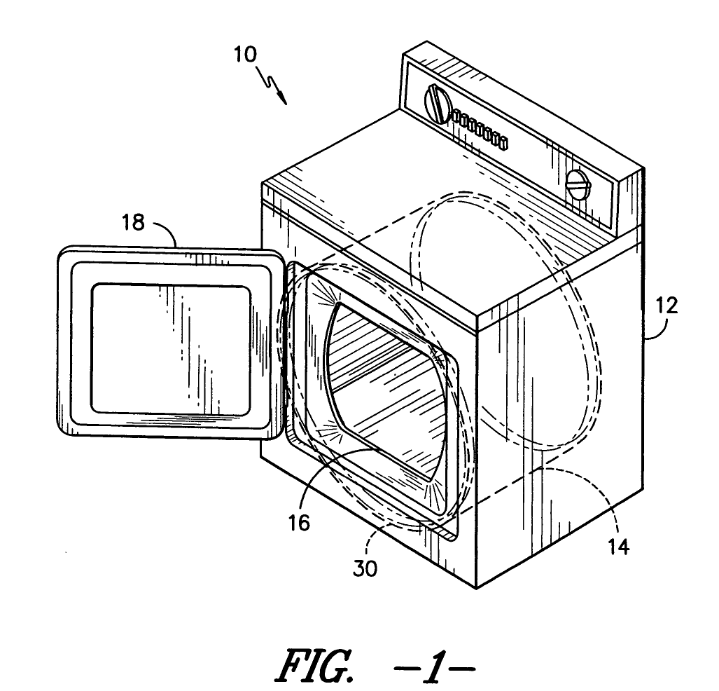

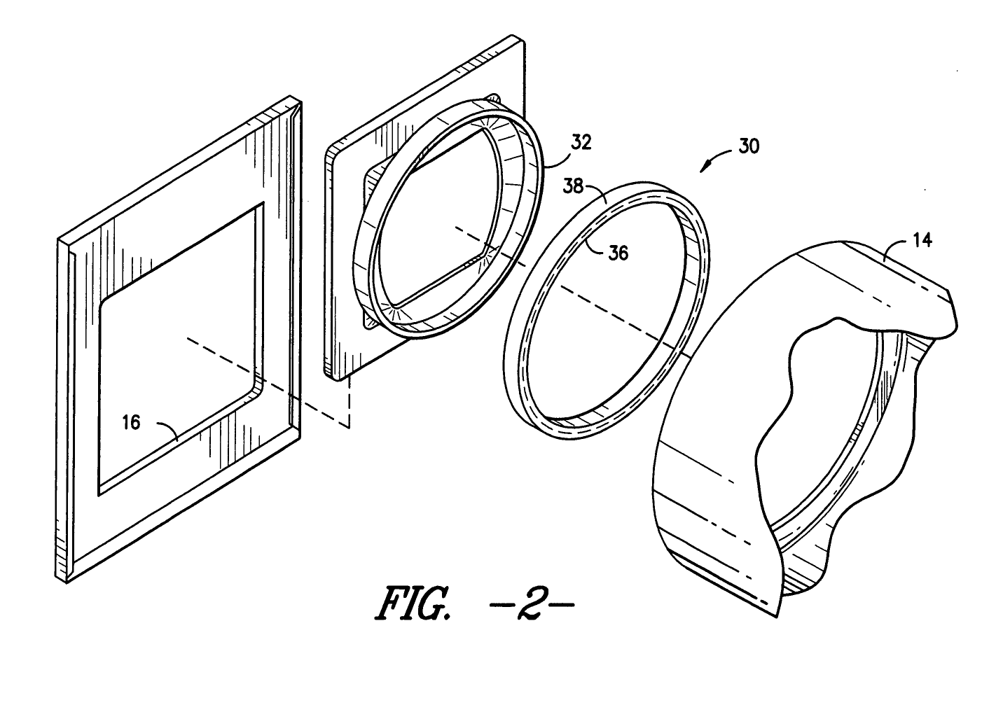

Reference will now be made to the various drawings wherein to the extent possible like reference numerals are utilized to designate corresponding components throughout the various views. In FIGS. 1 and 2, there is illustrated a dryer 10 including a cabinet body 12 housing a heated rotating drum 14. As illustrated, the cabinet body includes a door opening 16 for loading clothing articles into the mouth of the drum 14. The door opening 16 may be closed by means of a door 18.

As shown, a seal 30 in the form of a ring is disposed at a position within the forward portion of the dryer drum 14 thereby providing support between the drum 14 and a supporting structural member 32 such as a flange or the like while also blocking undesired air flow from the drum 14 into the surrounding cabinet 12. As shown, the seal 30 has a first or inner layer 36 arranged to be secured to the supporting structural member 32. The seal 30 also includes an outer layer 38 arranged to define a support surface for the drum 14. The seal 30 may also include various intermediate layers if desired. The layers may be joined to one another by needling such that fibers from the adjacent layers are intermingled into a cohesive structure at the interface.

The inner layer 36 defines the interior of the seal 30 and is preferably formed of a meltably bondable material that can be welded to the supporting structural member 32 by techniques such as ultrasonic welding, RF welding, vibration welding and the like thereby eliminating the need for adhesives. One suitable material for the underlying layer 36 is believed to be a polypropylene based material such as a medium density polypropylene based felt. Such materials have similar melt temperatures to polypropylene structural members thereby facilitating adhesion. Of course, other suitable materials that can be meltably bonded to the supporting structural member 32 may likewise be utilized if desired.

The outer layer 38 preferably provides a relatively low coefficient of friction with the supported drum while nonetheless retaining its structural integrity under heated conditions. It has been found that a wool/polyester blend needled felt may be particularly suitable. However, other materials may likewise be utilized if desired.

If desired, it is also contemplated that the layers can be reversed such that the polypropylene layer may be bonded in sealing attachment to an interior portion of the drum 14. The wool layer would then ride on the structural member.

The structure of the present invention provides excellent load bearing performance thereby eliminating the need for rollers, glides and the like. In addition, it provides sealing performance without the need for adhesive attachment.

While the present invention has been illustrated and described in relation to certain potentially preferred embodiments and practices, it is to be understood that such embodiments and practices are illustrative and exemplary only and that the present invention is in no event to be limited thereto. Rather, it is contemplated that modifications and variations to the present invention will no doubt occur to those of skill in the art upon reading the above description and/or through a practice of the invention. It is therefore contemplated and intended that the present invention shall extend to all such modifications and variations which incorporate the broad principles of the present invention within the full spirit and scope thereof.

1. In a clothes dryer, an air blocking seal comprising a first layer of fibrous material adapted to be disposed in contacting relation with a rotating dryer drum and at least one underlying layer held in melt bonded relation to a non-fibrous support structure.

2. The invention as recited in claim 1, wherein the first layer of fibrous material comprises a needled felt of wool and polyester fibers.

3. The invention as recited in claim 2, wherein the underlying layer is a felt comprising polypropylene fiber.

4. The invention as recited in claim 2, wherein the first layer of fibrous material is joined to the underlying layer by needling between the layers such that fibers from the first layer and from the underlying layer are intermingled across an interface between the layers.

5. A method of applying an air blocking seal to a clothes dryer, the method comprising:
(a) providing a fibrous seal element comprising a first layer of fibrous material and at least one underlying fibrous layer;
(b) placing the fibrous seal element at least partially around a support member such that the underlying fibrous layer is in contact with the support member; and
(c) adjoining the fibrous seal element to the support member by selective melt fusion of the underlying fibrous layer to the support member.

6. The invention as recited in claim 5, wherein the first layer of fibrous material comprises a needled felt of wool and polyester fibers.

7. The invention as recited in claim 6, wherein the underlying layer is a felt comprising polypropylene fiber.

8. The invention as recited in claim 7, wherein the first layer of fibrous material is joined to the underlying layer by needling between the layers such that fibers from the first layer and from the underlying layer are intermingled across an interface between the layers.

9. The invention as recited in claim 8, wherein the fibers from the first layer and from the underlying layer are intermingled across substantially the entire interface between the layers.
